(19) United States
(12) Patent Application Publication
(10) Pub. No.: US 2019/0266482 A1
(43) Pub. Date: Aug. 29, 2019

(54) DISTANCE BASED DEEP LEARNING

(71) Applicant: GSI Technology Inc., Sunnyvale, CA (US)

(72) Inventor: Elona Erez, Tel Aviv (IL)

(21) Appl. No.: 15/904,486

(22) Filed: Feb. 26, 2018

(51) Int. Cl. G06N 3/08; G06N 7/00

(52) U.S. Cl. CPC G06N 3/08; G06N 7/005

(57) ABSTRACT

A method for a neural network includes concurrently calculating a distance vector between an output feature vector describing an unclassified item and each of a plurality of qualified feature vectors, each describing one classified item out of a collection of classified items. The method includes concurrently computing a similarity score for each distance vector and creating a similarity score vector of the plurality of computed similarity scores. A system for a neural network includes an associative memory array, an input arranger, a hidden layer computer and an output handler. The input arranger manipulates information describing an unclassified item stored in the memory array. The hidden layer computer computes a hidden layer vector. The output handler computes an output feature vector and concurrently calculates a distance vector between an output feature vector and each of a plurality of qualified feature vectors, and concurrently computes a similarity score for each distance vector.

### FIELD OF THE INVENTION

The present invention relates to associative memory devices generally and to deep learning in associative memory devices in particular.

### BACKGROUND OF THE INVENTION

Neural networks are computing systems that learn to do tasks by considering examples, generally without task-specific programming. A typical neural network is an interconnected group of nodes organized in layers; each layer may perform a different transformation on its input. A neural network may be mathematically represented as vectors, representing the activation of nodes in a layer, and matrices, representing the weights of the interconnections between nodes of adjacent layers. The network functionality is a series of mathematical operations performed on and between the vectors and matrices, and nonlinear operations performed on values stored in the vectors and the matrices.

Throughout this application, matrices are represented by capital letters in bold, e.g. A, vectors in lowercase bold, e.g. a, and entries of vectors and matrices represented by italic fonts e.g. A and a. Thus, the i, j entry of matrix A is indicated by Aᵢⱼ, row i of matrix A is indicated as Aᵢ, column j of matrix A is indicated as A₋ⱼ and entry i of vector a is indicated by aᵢ.

Recurrent neural networks (RNNs) are special types of neural networks useful for operations on a sequence of values when the output of the current computation depends on the value of the previous computation. LSTM (long short-term memory) and GRU (gated recurrent unit) are examples of RNNs.

The output feature vector of a network (both recurrent and non-recurrent) is a vector h storing m numerical values. In language modeling h may be the output embedding vector (a vector of numbers (real, integer, finite precision etc.) representing a word or a phrase in a vocabulary), and in other deep learning disciplines, h may be the features of the object in question. Applications may need to determine the item represented by vector h. In language modeling, h may represent one word, out of a vocabulary of v words, which the application may need to identify. It may be appreciated that v may be very large, for example, v is approximately 170,000 for the English language.

The RNN in FIG. 1 is illustrated in in two representations: folded 100A and unfolded 100B. The unfolded representation 100B describes the RNN over time, in times t−1, t and t+1. In the folded representation, vector x is the “general” input vector, and in the unfolded representation, xₜ represents the input vector at time t. It may be appreciated that the input vector xₜ represents an item in a sequence of items handled by the RNN. The vector xₜ may represent item k out of a collection of v items by a “one-hot” vector, i.e. a vector having all zeros except for a single “1” in position k. Matrices W, U and Z are parameter matrices, created with specific dimensions to fit the planned operation. The matrices are initiated with random values and updated during the operation of the RNN, during a training phase and sometimes also during an inference phase.

In the folded representation, vector h represents the hidden layer of the RNN. In the unfolded representation, hₜ is the value of the hidden layer at time t, calculated from the value of the hidden layer at time t−1 according to equation 1:

hₜ=f(U*x+W*hₜ₋₁) Equation 1

In the folded representation, y represents the output vector. In the unfolded representation, yₜ is the output vector at time t having, for each item in the collection of v items, a probability of being the class of the item at time t. The probability may be calculated using a nonlinear function, such as SoftMax, according to equation 2:

yₜ=softmax(Z*hₜ) Equation 2

Where Z is a dimension adjustment matrix meant to adjust the size of hₜ to the size of yₜ.

RNNs are used in many applications handling sequences of items such as: language modeling (handling sequences of words); machine translation; speech recognition; dialogue; video annotation (handling sequences of pictures); handwriting recognition (handling sequences of signs); image-based sequence recognition and the like.

Language modeling, for example, computes the probability of occurrence of a number of words in a particular sequence. A sequence of m words is given by {w₁, . . . , wₘ}. The probability of the sequence is defined by p(w₁, . . . , wₘ) and the probability of a word wᵢ, conditioned on all previous words in the sequence, can be approximated by a window of n previous words as defined in equation 3:

p(w₁, . . . ,wₘ)=Σᵢ₌₁ⁱ⁼²p(wᵢ|w₁, . . . ,wᵢ₋₁)≠Πᵢ₌₁^{i=m}p(wᵢ|wᵢ₋ₙ, . . . ,wᵢ₋₁) Equation 3

The probability of a sequence of words can be estimated by empirically counting the number of times each combination of words occurs in a corpus of texts. For n words, the combination is called an n-gram, for two words, it is called bi-gram. Memory requirements for counting the number of occurrences of n-grams grows exponentially with the window size n making it extremely difficult to model large windows without running out of memory.

RNNs may be used to model the likelihood of word sequences, without explicitly having to store the probabilities of each sequence. The complexity of the RNN computation for language modeling is proportional to the size v of the vocabulary of the modeled language. It requires massive matrix vector multiplications and a SoftMax operation which are heavy computations.

### SUMMARY OF THE PRESENT INVENTION

There is provided, in accordance with a preferred embodiment of the present invention, a method for a neural network. The method includes concurrently calculating a distance vector between an output feature vector of the neural network and each of a plurality of qualified feature vectors. The output feature vector describes an unclassified item, and each of the plurality of qualified feature vectors describes one classified item out of a collection of classified items. The method further includes concurrently computing a similarity score for each distance vector; and creating a similarity score vector of the plurality of computed similarity scores.

Moreover, in accordance with a preferred embodiment of the present invention, the method also includes reducing a size of an input vector of the neural network by concurrently multiplying the input vector by a plurality of columns of an input embedding matrix.

Furthermore, in accordance with a preferred embodiment of the present invention, the method also includes concurrently activating a nonlinear function on all elements of the similarity score vector to provide a probability distribution vector.

Still further, in accordance with a preferred embodiment of the present invention, the nonlinear function is the SoftMax function.

Additionally, in accordance with a preferred embodiment of the present invention, the method also includes finding an extreme value in the probability distribution vector to find a classified item most similar to the unclassified item with a computation complexity of O(1).

Moreover, in accordance with a preferred embodiment of the present invention, the method also includes activating a K-nearest neighbors (KNN) function on the similarity score vector to provide k classified items most similar to the unclassified item.

There is provided, in accordance with a preferred embodiment of the present invention, a system for a neural network. The system includes an associative memory array, an input arranger, a hidden layer computer and an output handler. The associative memory array includes rows and columns. The input arranger stores information regarding an unclassified item in the associative memory array, manipulates the information and creates input to the neural network. The hidden layer computer receives the input and runs the input in the neural network to compute a hidden layer vector. The output handler transforms the hidden layer vector to an output feature vector and concurrently calculates, within the associative memory array, a distance vector between the output feature vector and each of a plurality of qualified feature vectors, each describing one classified item. The output handler also concurrently computes, within the associative memory array, a similarity score for each distance vector.

Moreover, in accordance with a preferred embodiment of the present invention, the input arranger reduces the dimension of the information.

Furthermore, in accordance with a preferred embodiment of the present invention, the output handler also includes a linear module and a nonlinear module.

Still further, in accordance with a preferred embodiment of the present invention, the nonlinear module implements the SoftMax function to create a probability distribution vector from a vector of the similarity scores.

Additionally, in accordance with a preferred embodiment of the present invention, the system also includes an extreme value finder to find an extreme value in the probability distribution vector.

Furthermore, in accordance with a preferred embodiment of the present invention, the nonlinear module is a k-nearest neighbor module that provides k classified items most similar to the unclassified item.

Still further, in accordance with a preferred embodiment of the present invention, the linear module is a distance transformer to generate the similarity scores.

Additionally, in accordance with a preferred embodiment of the present invention, the distance transformer also includes a vector adjuster and a distance calculator.

Moreover, in accordance with a preferred embodiment of the present invention, the distance transformer stores columns of an adjustment matrix in first computation columns of the memory array and distributes the hidden layer vector to each computation column, and the vector adjuster computes an output feature vector within the first computation columns.

Furthermore, in accordance with a preferred embodiment of the present invention, the distance transformer initially stores columns of an output embedding matrix in second computation columns of the associative memory array and distributes the output feature vector to all second computation columns, and the distance calculator computes a distance vector within the second computation columns.

There is provided, in accordance with a preferred embodiment of the present invention, a method for comparing an unclassified item described by an unclassified vector of features to a plurality of classified items, each described by a classified vector of features. The method includes concurrently computing a distance vector between the unclassified vector and each classified vector; and concurrently computing a distance scalar for each distance vector, each distance scalar providing a similarity score between the unclassified item and one of the plurality of classified items thereby creating a similarity score vector comprising a plurality of distance scalars.

Additionally, in accordance with a preferred embodiment of the present invention, the method also includes activating a nonlinear function on the similarity score vector to create a probability distribution vector.

Furthermore, in accordance with a preferred embodiment of the present invention, the nonlinear function is the SoftMax function.

Still further, in accordance with a preferred embodiment of the present invention, the method also includes finding an extreme value in the probability distribution vector to find a classified item most similar to the unclassified item.

Moreover, in accordance with a preferred embodiment of the present invention, the method also includes activating a K-nearest neighbors (KNN) function on the similarity score vector to provide k classified items most similar to the unclassified item.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a prior art RNN in a folded and an unfolded representation;

FIG. 2 is an illustration of a neural network output handler, constructed and operative in accordance with the present invention;

FIG. 3 is a schematic illustration of an RNN computing system, constructed and operative in accordance with an embodiment of the present invention;

FIG. 4 is a schematic illustration of an input arranger forming part of the neural network of FIG. 1, constructed and operative in accordance with an embodiment of the present invention;

FIG. 5 is a schematic illustration of a hidden layer computer forming part of the neural network of FIG. 1, constructed and operative in accordance with an embodiment of the present invention;

FIG. 6 is a schematic illustration of an output handler forming part of the RNN processor of FIG. 3, constructed and operative in accordance with an embodiment of the present invention;

FIG. 7A is a schematic illustration of a linear module forming part of the output handler of FIG. 6 that provides the linear transformations by a standard transformer;

FIG. 7B is a schematic illustration of a distance transformer alternative of the linear module of the output handler of FIG. 6, constructed and operative in accordance with an embodiment of the present invention;

FIG. 8 is a schematic illustration of the data arrangement of matrices in the associative memory used by the distance transformer of FIG. 7B;

FIG. 9 is a schematic illustration of the data arrangement of a hidden layer vector and the computation steps performed by the distance transformer of FIG. 7B; and

FIG. 10 is a schematic flow chart, operative in accordance with the present invention, illustrating the operation performed by RNN computing system of FIG. 3.

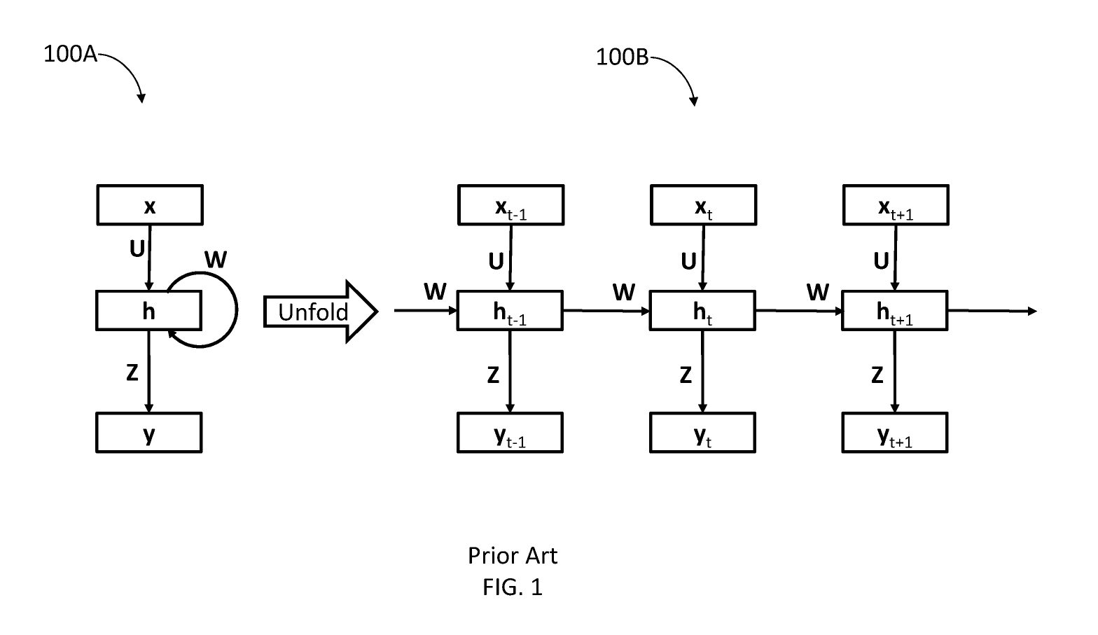

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that associative memory devices may be utilized to efficiently implement parts of artificial networks, such as RNNs (including LSTMs (long short-term memory) and GRUs (gated recurrent unit)). Systems as described in U.S. patent Publication US 2017/0277659 entitled “IN MEMORY MATRIX MULTIPLICATION AND ITS USAGE IN NEURAL NETWORKS”, assigned to the common assignee of the present invention and incorporated herein by reference, may provide a linear or event constant complexity for the matrix multiplication part of a neural network computation. Systems as described in U.S. patent application Ser. No. 15/784,152 filed Oct. 15, 2017 entitled “PRECISE EXPONENT AND EXACT SOFTMAX COMPUTATION”, assigned to the common assignee of the present invention and incorporated herein by reference, may provide a constant complexity for the nonlinear part of an RNN computation in both training and inference phases, and the system described in U.S. patent application Ser. No. 15/648,475 filed Jul. 13, 2017 entitled “FINDING K EXTREME VALUES IN CONSTANT PROCESSING TIME”, assigned to the common assignee of the present invention and incorporated herein by reference, may provide a constant complexity for the computation of a K-nearest neighbor (KNN) on a trained RNN.

Applicant has realized that the complexity of preparing the output of the RNN computation is proportional to the size v of the collection, i.e. the complexity is O(v). For language modeling, the collection is the entire vocabulary, which may be very large, and the RNN computation may include massive matrix vector multiplications and a complex SoftMax operation to create a probability distribution vector that may provide an indication of the class of the next item in a sequence.

Applicant has also realized that a similar probability distribution vector, indicating the class of a next item in a sequence, may be created by replacing the massive matrix vector multiplications by a much lighter distance computation, with a computation complexity of O(d) where d is much smaller than v. In language modeling, for instance, d may be chosen to be 100 (or 200, 500 and the like) compared to a vocabulary size v of 170,000. It may be appreciated that the vector matrix computation may be implemented by the system of U.S. Patent Publication US 2017/0277659.

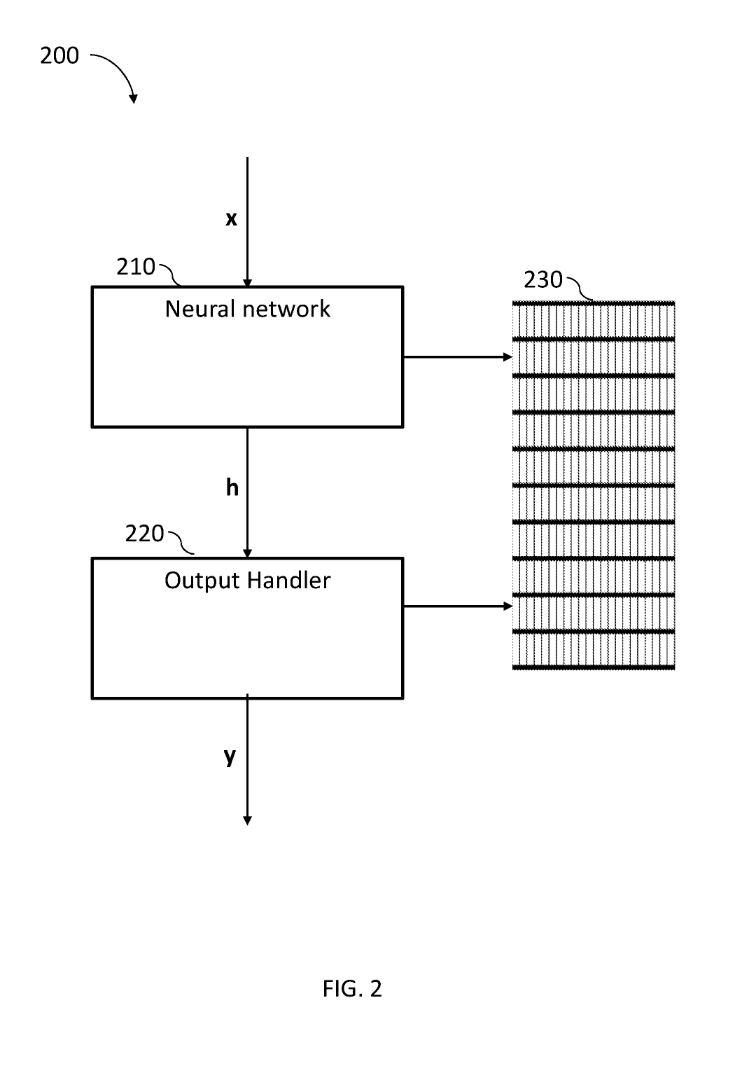

FIG. 2, to which reference is now made, is a schematic illustration of a neural network output handler system 200 comprising a neural network 210, an output handler 220, and an associative memory array 230, constructed and operative in accordance with the present invention.

Associative memory array 230 may store the information needed to perform the computation of an RNN and may be a multi-purpose associative memory device such as the ones described in U.S. Pat. No. 8,238,173 (entitled “USING STORAGE CELLS TO PERFORM COMPUTATION”); U.S. patent application Ser. No. 14/588,419, filed on Jan. 1, 2015 (entitled “NON-VOLATILE IN-MEMORY COMPUTING DEVICE”); U.S. patent application Ser. No. 14/555,638 filed on Nov. 27, 2014 (entitled “IN-MEMORY COMPUTATIONAL DEVICE”); U.S. Pat. No. 9,558,812 (entitled “SRAM MULTI-CELL OPERATIONS”) and U.S. patent application Ser. No. 15/650,935 filed on Jul. 16, 2017 (entitled “IN-MEMORY COMPUTATIONAL DEVICE WITH BIT LINE PROCESSORS”) all assigned to the common assignee of the present invention and incorporated herein by reference.

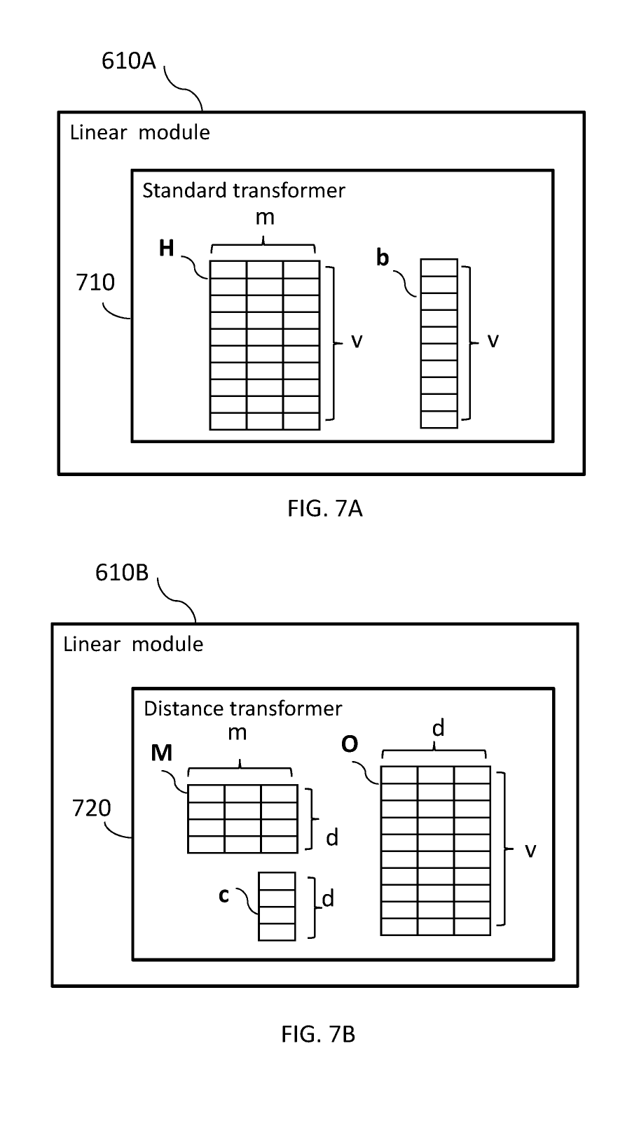

Neural network 210 may be any neural network package that receives an input vector x and provides an output vector h. Output handler 220 may receive vector h as input and may create an output vector y containing the probability distribution of each item over the collection. For each possible item in the collection, output vector y may provide its probability of being the class of the expected item in a sequence. In word modeling, for example, the class of the next expected item may be the next word in a sentence. Output handler 220 is described in detail with respect to FIGS. 7-10.

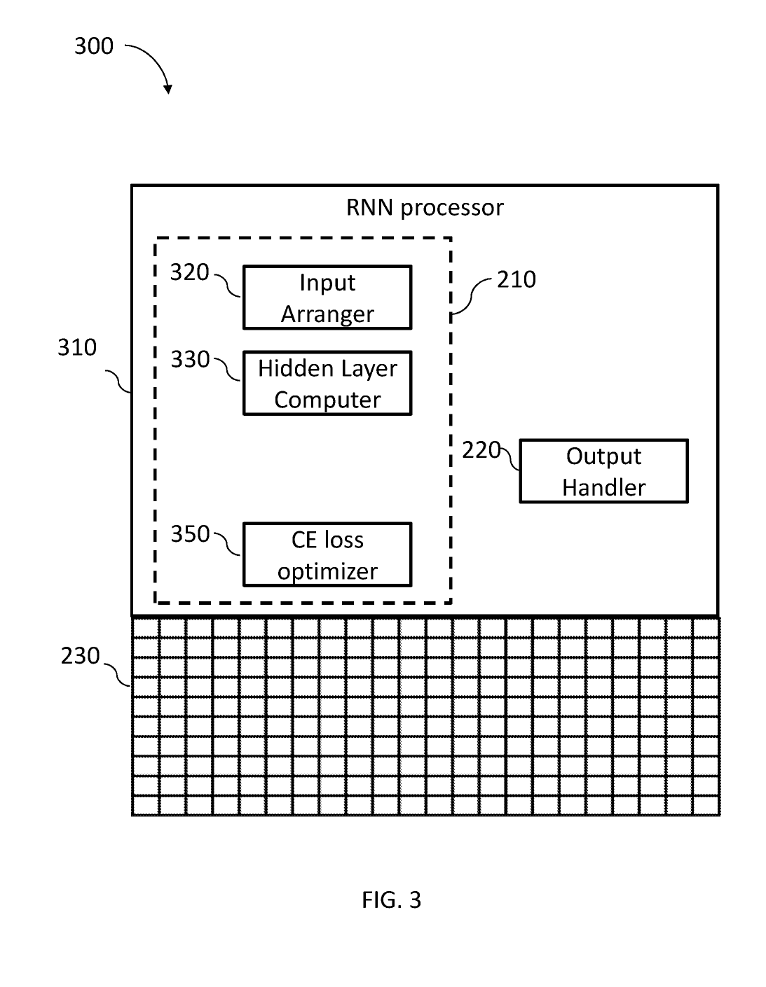

FIG. 3, to which reference is now made, is a schematic illustration of an RNN computing system 300, constructed and operative in accordance with an embodiment of the present invention, comprising an RNN processor 310 and an associative memory array 230.

RNN processor 310 may further comprise a neural network package 210 and an output handler 2. Neural network package 210 may further comprise an input arranger 320, a hidden layer computer 330, and a cross entropy (CE) loss optimizer 350.

In one embodiment, input arranger 320 may receive a sequence of items to be analyzed (sequence of words, sequence of figures, sequence of signs, etc.) and may transform each item in the sequence to a form that may fit the RNN. For example, an RNN for language modeling may need to handle a very large vocabulary (as mentioned above, the size v of the English vocabulary, for example, is about 170,000 words). The RNN for language modeling may receive as input a plurality of one-hot vectors, each representing one word in the sequence of words. It may be appreciated that the size v of a one-hot vector representing an English word may be 170,000 bits. Input arranger 320 may transform the large input vector to a smaller sized vector that may be used as the input of the RNN.

Hidden layer computer 330 may compute the value of the activations in the hidden layer using any available RNN package and CE loss optimizer 350 may optimize the loss.

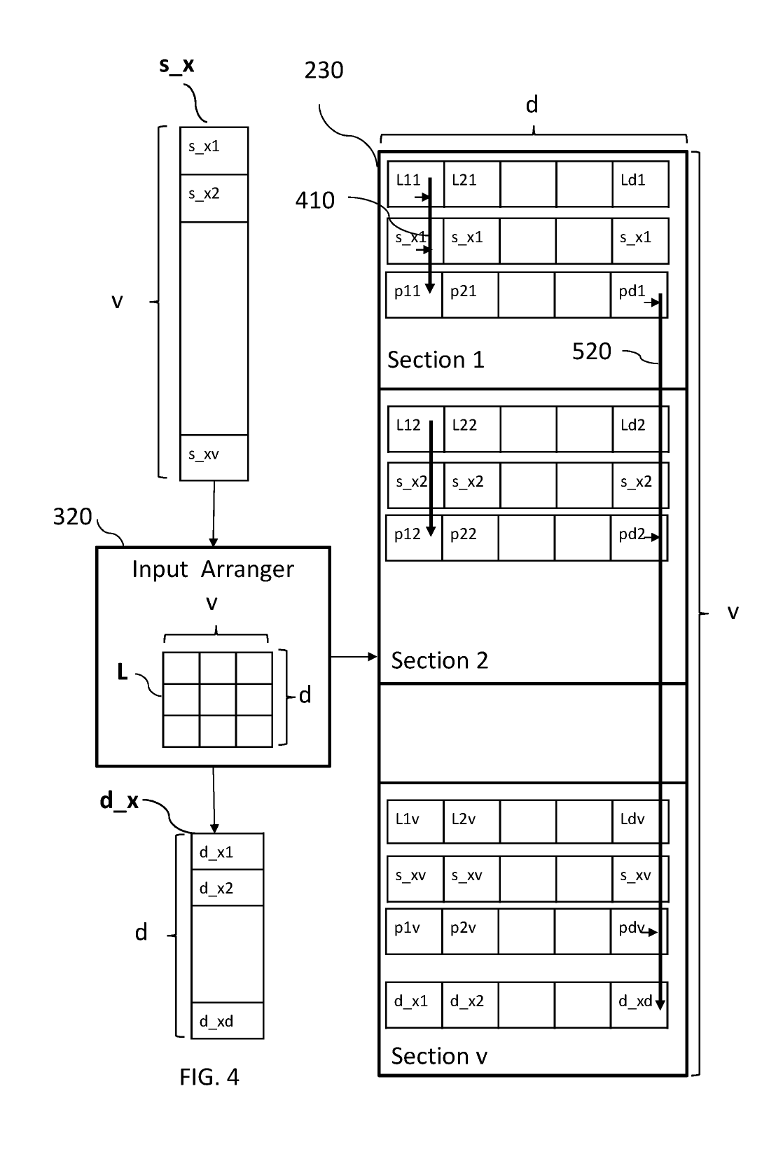

FIG. 4, to which reference is now made, is a schematic illustration of input arranger 320, constructed and operative in accordance with an embodiment of the present invention. Input arranger 320 may receive a sparse vector as input. The vector may be a one-hot vector s_x, representing a specific item from a collection of v possible items, and may create a much smaller vector d_x, (whose size is d) that represents the same item from the collection. Input arranger 320 may perform the transformation of vector s_x to vector d_x using a matrix L whose size is d×v. Matrix L, may contain, after the training of the RNN, in each column k, a set of features characterizing item k of the collection. Matrix L may be referred to as the input embedding matrix or as the input dictionary and is defined in equation 4:

d_x=L*s_x Equation 4

Input arranger 320 may initially store a row Lᵢ. of matrix L, in a first row of an ith section of associative memory array 230. Input arranger 320 may concurrently distribute a bit i of the input vector s_x to each computation column j of a second row of section i. Input arranger 320 may concurrently, in all sections i and in all computation columns j, multiply the value Lᵢⱼ by s_xⱼ. to produce a value pᵢⱼ, as illustrated by arrow 410. Input arranger 320 may then add, per computation column j, the multiplication results pᵢⱼ in all sections, as illustrated by arrow 520, to provide the output vector d_x of equation 4.

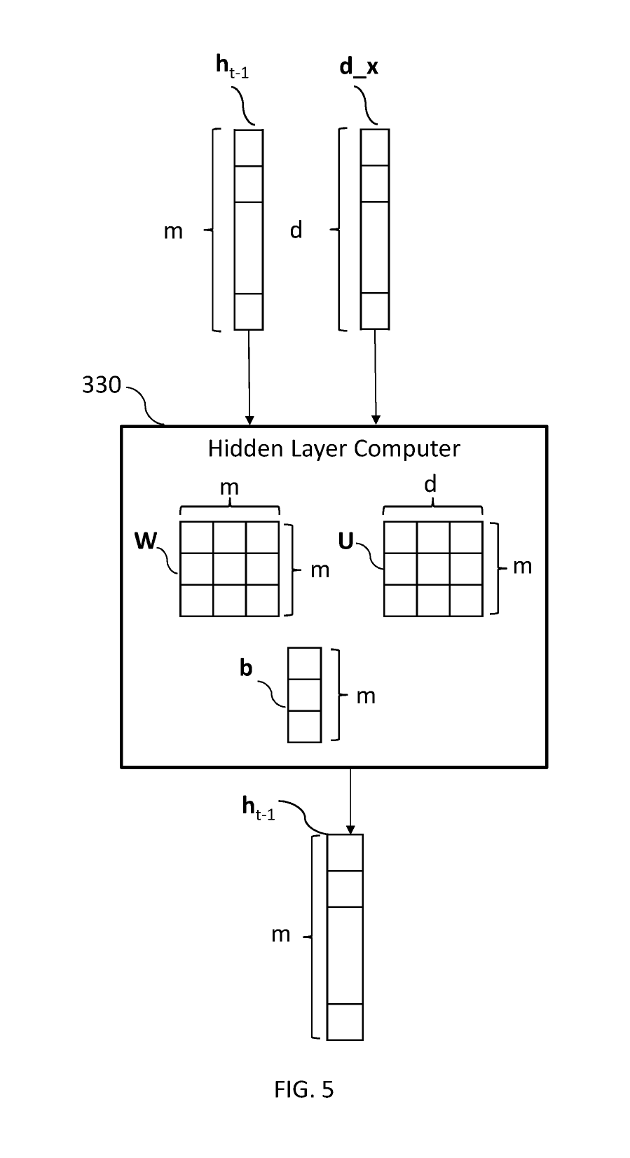

FIG. 5, to which reference is now made, is a schematic illustration of hidden layer computer 330. Hidden layer computer 330 may comprise any available neural network package. Hidden layer computer 330 may compute a value for the activations hₜ, in the hidden layer at time t, based on the input vector in its dense representation at time t, d_xₜ, and the previous value h_{t_1} of the activations, at time t−1, according to equation 5:

hₜ=σ(W*hₜ₋₁+U*d_xₜ+b) Equation 5

As described hereinabove, d, the size of h, may be determined in advance and is the smaller dimension of embedding matrix L. σ is a non-linear function, such as the sigmoid function, operated on each element of the resultant vector. W and U are predefined parameter matrices and b is a bias vector. W and U may be typically initiated to random values and may be updated during the training phase. The dimensions of the parameter matrices W (m×m) and U (m×d) and the bias vector b (m) may be defined to fit the sizes of h and d_x respectively.

Hidden layer computer 330 may calculate the value of the hidden layer vector at time t using the dense vector d_x and the results hₜ₋₁ of the RNN of the previous step. The result of the hidden layer is h. The initial value of h is h₀ which may be random.

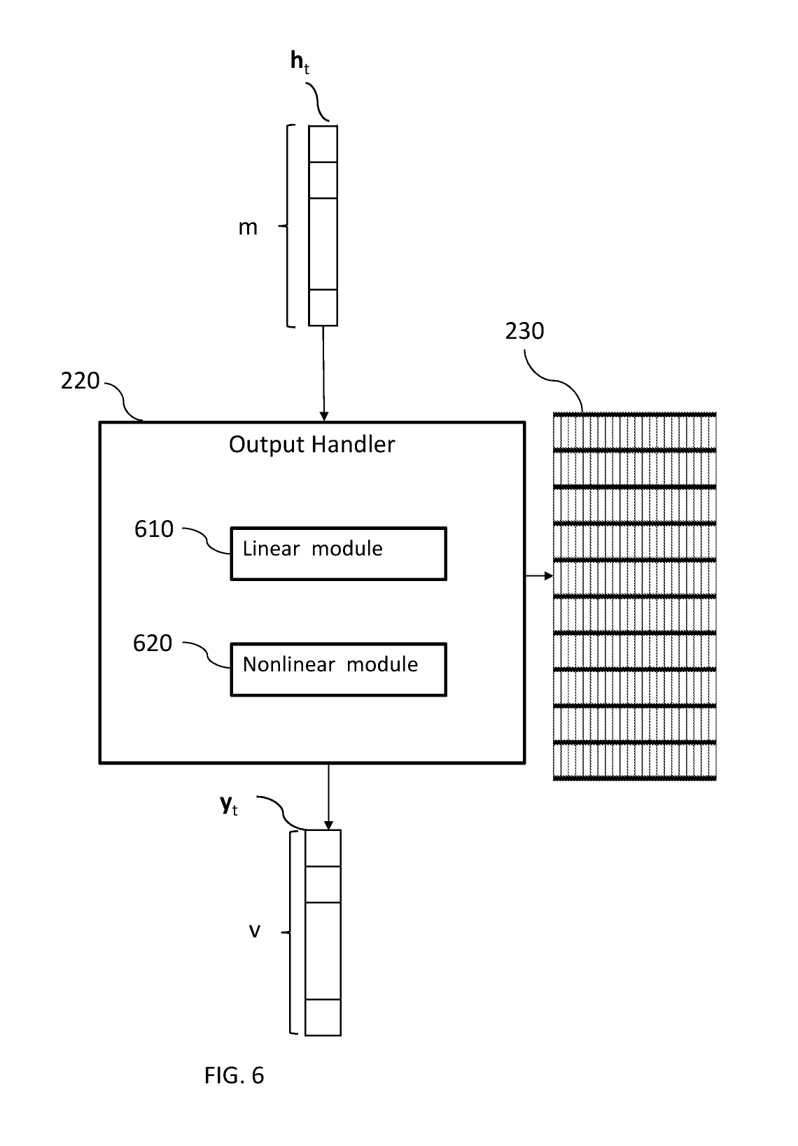

FIG. 6, to which reference is now made, is a schematic illustration of output handler 220, constructed and operative in accordance with an embodiment of the present invention.

Output handler may create output vector yₜ using a linear module 610 for arranging vector h (the output of the hidden layer computer 330) to fit the size v of the collection, followed by a nonlinear module 620 to create the probability for each item. Linear module 610 may implement a linear function g and nonlinear module 620 may implement a nonlinear function f. The probability distribution vector yₜ may be computed according to equation 6:

yₜ=f(g(hₜ)) Equation 6

The linear function g may transform the received embedding vector h (created by hidden layer computer 330) having size m to an output vector of size d. During the transformation of the embedding vector h, the linear function g may create an extreme score value hₖ (maximum or minimum) in location k of vector h.

FIG. 7A, to which reference is now made, is a schematic illustration of linear module 610A, that may provide the linear transformations by a standard transformer 710 implemented by a standard package.

Standard transformer 710 may be provided by a standard package and may transform the embedding vector hₜ to a vector of size v using equation 7:

g(hₜ)=(H*hₜ+b) Equation 7

Where H is an output representation matrix (v×m). Each row of matrix H may store the embedding of one item (out of the collection) as learned during the training session and vector b may be a bias vector of size v. Matrix H may be initiated to random values and may be updated during the training phase to minimize a cross entropy loss, as is known in the art.

It may be appreciated that the multiplication of vector hₜ by a row j of matrix H (storing the embedding vector of each classified item j) may provide a scalar score indicating the similarity between each classified item j and the unclassified object represented by vector hₜ. The higher the score is, the more similar the vectors are. The result g(h) is a vector (of size v) having a score indicating for each location j the similarity between the input item and an item in row j of matrix H. The location k in g(h) having the highest score value indicates item k in matrix H (storing the embedding of each item in the collection) as the class of the unclassified item.

It may also be appreciated that H*hₜ requires a heavy matrix vector multiplication operation since H has v rows, each storing the embedding of a specific item, and v is the size of the entire collection (vocabulary) which, as already indicated, may be very large. Computing all inner products (between each row in H and hₜ) may become prohibitively slow during training, even when exploiting modern GPUs.

Applicant has realized that output handler 220 may utilize memory array 230 to significantly reduce the computation complexity of linear module 610.

FIG. 7B, to which reference is now made, is a schematic illustration of linear module 610B, constructed and operative in accordance with an embodiment of the present invention. Distance transformer 720 may calculate the distance between the output embedding vector h and each item j stored as a column of an output embedding matrix O, as defined in equation 8, instead of multiplying it by the large matrix H:

(g(hₜ))ⱼ=distance((M*hₜ+c)−O₋ⱼ) Equation 8

Where (g(hₜ))ⱼ is a scalar computed for a column j of output embedding matrix O and may provide a distance score between hₜ and vector j of matrix O. The size of vector hₜ may be different than the size of a column of matrix O; therefore, a dimension adjustment matrix M, meant to adjust the size of the embedding vector hₜ to the size of 0, may be needed to enable the distance computation. The dimensions of M may be d×m, much smaller than the dimension of H used in standard transformer 710, and therefore, the computation of distance transformer 720 may be much faster and less resource consuming than the computation of standard transformer 710. Vector c is a bias vector.

Output embedding matrix O may be initiated to random values and may be updated during the training session. Output embedding matrix O may store, in each column j, the calculated embedding of item j (out of the collection). Output embedding matrix O may be similar to the input embedding matrix L used by input arranger 320 (FIG. 4) and may even be identical to L. It may be appreciated that matrix O, when used in applications other than language modeling, may store in each column j the features of item j.

The distance between the unclassified object and the database of classified objects may be computed using any distance or similarity method such as L1 or L2 norms, hamming distance, cosine similarity or any other similarity or distance method to calculate the distance (or the similarity) between the unclassified object, defined by hₜ, and the database of classified objects stored in matrix O.

A norm is a distance function that may assign a strictly positive value to each vector in a vector space and may provide a numerical value to express the similarity between vectors. The norm may be computed between hₜ and each column j of matrix O (indicated by O₋ⱼ). The output embedding matrix O is an analogue to matrix H but may be trained differently and may have a different number of columns.

The result of multiplying the hidden layer vector h by the dimension adjustment matrix M may create a vector o with a size identical to the size of a column of matrix O enabling the subtraction of vector o from each column of matrix O during the computation of the distance. It may be appreciated that distance transformer 720 may add a bias vector c to the resultant vector o and for simplicity, the resultant vector may still be referred to as vector o.

As already mentioned, distance transformer 720 may compute the distance using the L1 or L2 norms. It may be appreciated that the L1 norm, known as the “least absolute deviations” norm defines the absolute differences between a target value and estimated values while the L2 norm, known as the “least squares error” norm, is the sum of the square of the differences between the target value and the estimated values. The result of each distance calculation is a scalar, and the results of all calculated distances (the distance between vector o and each column of matrix O) may provide a vector g(h).

The distance calculation may provide a scalar score indicating the difference or similarity between the output embedding vector o and the item stored in a column j of matrix O. When a distance is computed by a norm, the lower the score is, the more similar the vectors are. When a distance is computed by a cosine similarity, the higher the score is, the more similar the vectors are. The resultant vector g(h) (of size v) is a vector of scores. The location k in the score vector g(h) having an extreme (lowest or highest) score value, (depending on the distance computation method), may indicate that item k in matrix O (storing the embedding of each item in the collection) is the class of the unclassified item hₜ.

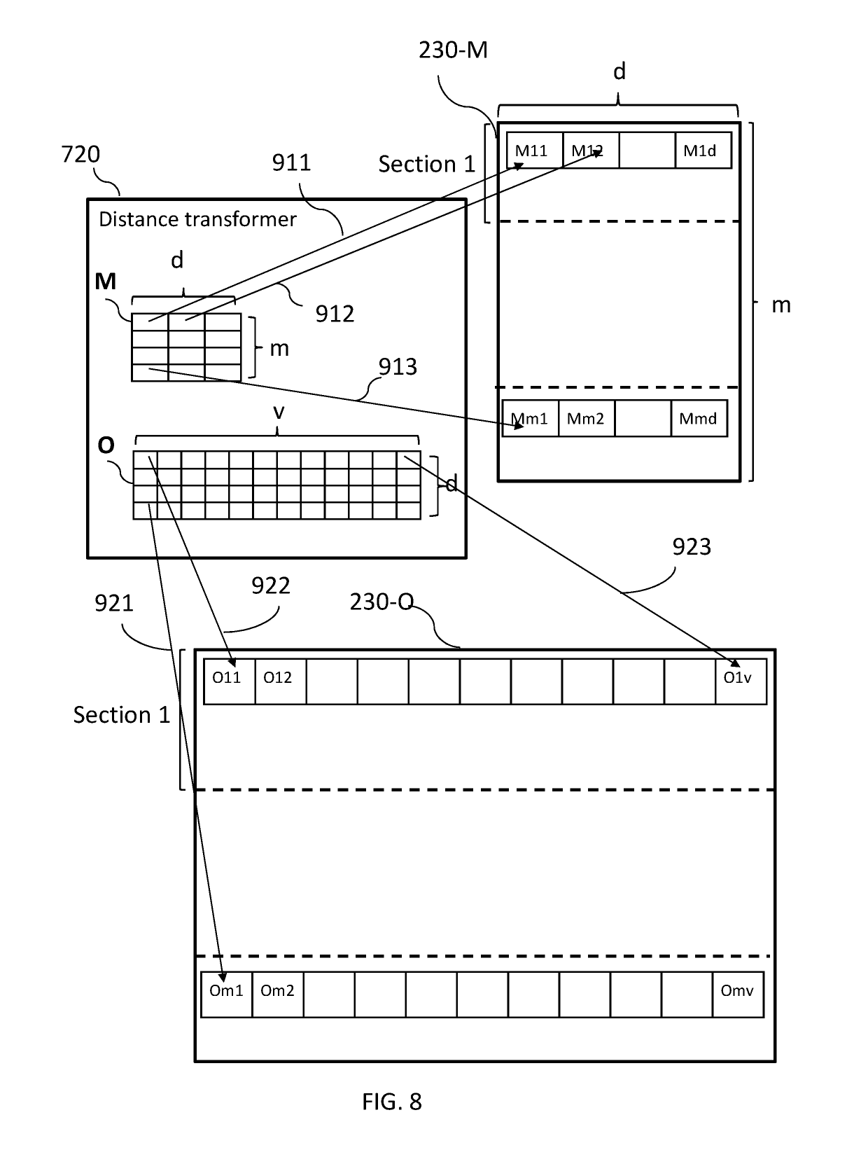

FIG. 8, to which reference is now made, is a schematic illustration of the data arrangement of matrix M and matrix O in memory array 230. Distance transformer 720 may utilize memory array 230 such that one part, 230-M, may store matrix M and another part, 230-O, may store matrix O. Distance transformer 720 may store each row i of matrix M in a first row of the ith section of memory array part 230-M (each bit i of column j of matrix M may be stored in a same computation column j of a different section i), as illustrated by arrows 911, 912 and 913.

Similarly, distance transformer 720 may store each row i of matrix O in a first row of the ith section of memory array part 230-O, as illustrated by arrows 921, 922 and 923.

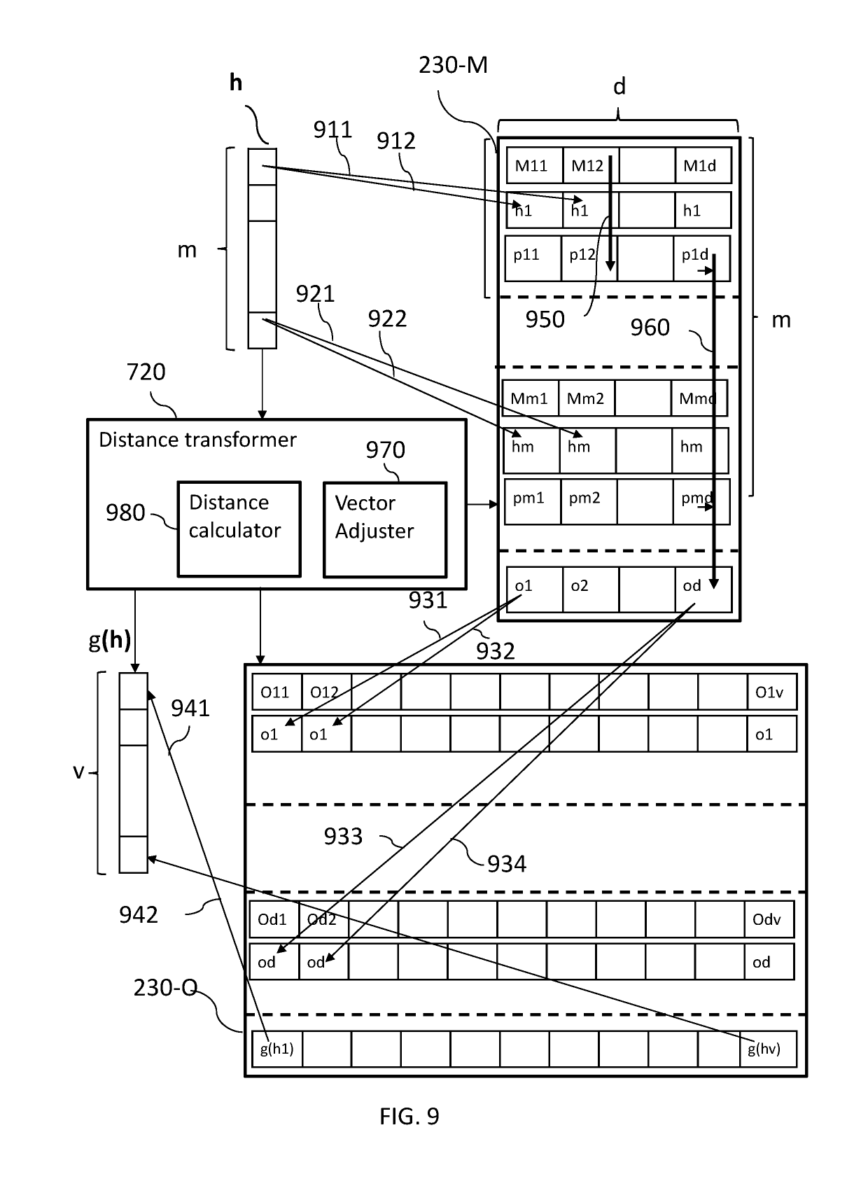

FIG. 9, to which reference is now made, is a schematic illustration of the data arrangement of vector h and the computation steps performed by distance transformer 720. Distance transformer 720 may further comprise a vector adjuster 970 and a distance calculator 980. Vector adjuster 970 may distribute each bit i of embedding vector hₜ, to all computation columns of a second row of section i of memory array part 230-M such that, bit i of vector hₜ is repeatedly stored throughout an entire second row of section i, in the same section where row i of matrix M is stored. Bit hl may be distributed to a second row of section 1 as illustrated by arrows 911 and 912 and bit hm may be distributed to a second row of section m as illustrated by arrows 921 and 922.

Vector adjuster 970 may concurrently, on all computation columns in all sections, multiply Mᵢⱼ by hᵢ and may store the results pᵢⱼ in a third row, as illustrated by arrow 950. Vector adjuster 970 may concurrently add, on all computation columns, the values of pᵢ to produce the values oᵢ of vector o, as illustrated by arrow 960.

Once vector o is calculated for embedding vector hₜ, distance transformer 720 may add a bias vector c, not shown in the figure, to the resultant vector o.

Distance transformer 720 may distribute vector o to memory array part 230-O such that each value oᵢ is distributed to an entire second row of section i. Bit ol may be distributed to a second row of section 1 as illustrated by arrows 931 and 932 and bit od may be distributed to a second row of section d as illustrated by arrows 933 and 934.

Distance calculator 980 may concurrently, on all computation columns in all sections, subtract of from Oᵢⱼ to create a distance vector. Distance calculator 980 may then finalize the computation of g(h) by computing the L1 or L2 or any other distance computation for each resultant vector and may provide the result g(h) as an output, as illustrated by arrows 941 and 942

It may be appreciated that in another embodiment, distance transformer 720 may write each addition result oᵢ, of vector o, directly on the final location in memory array part 230-O.

System 300 (FIG. 3) may find, during the inference phase, the extreme (smallest or largest) value in vector g(h) to determine the class of the expected next item, using the system of U.S. patent application Ser. No. 14/594,434 filed Jan. 12, 2015 entitled “MEMORY DEVICE” and published as US 2015/0200009, which is incorporated herein by reference.

Nonlinear module 620 (FIG. 6) may implement a nonlinear function f that may transform the arbitrary values created by the linear function g and stored in g(h) to probabilities. Function f may, for example, be the SoftMax operation and in such case, nonlinear module 620 may utilize the Exact SoftMax system of U.S. patent application Ser. No. 15/784,152 filed Oct. 15, 2017 and entitled “PRECISE EXPONENT AND EXACT SOFTMAX COMPUTATION”, incorporated herein by reference.

Additionally or alternatively, RNN computing system 300 may utilize U.S. patent application Ser. No. 15/648,475 filed Jul. 7, 2017 entitled “FINDING K EXTREME VALUES IN CONSTANT PROCESSING TIME” to find the k-nearest neighbors during inference when several results are required, instead of one. An example of such a usage of RNN computing system 300 may be in a beam search where nonlinear module 620 may be replaced by a KNN module to find the k items having extreme values, each representing a potential class for the unclassified item.

CE loss optimizer 350 (FIG. 3) may calculate a cross entropy loss, during the learning phase using any standard package, and may optimize it using equation 9:

CE(y_{expected},yₜ)=−Σᵢ₌₁^{v}yₜ log((y_{expected})_{I} Equation 9

Where yₜ is the one-hot vector of the expected output, y_{expected} is the probability vector storing in each location k the probability that an item in location k is the class of the unclassified expected item.

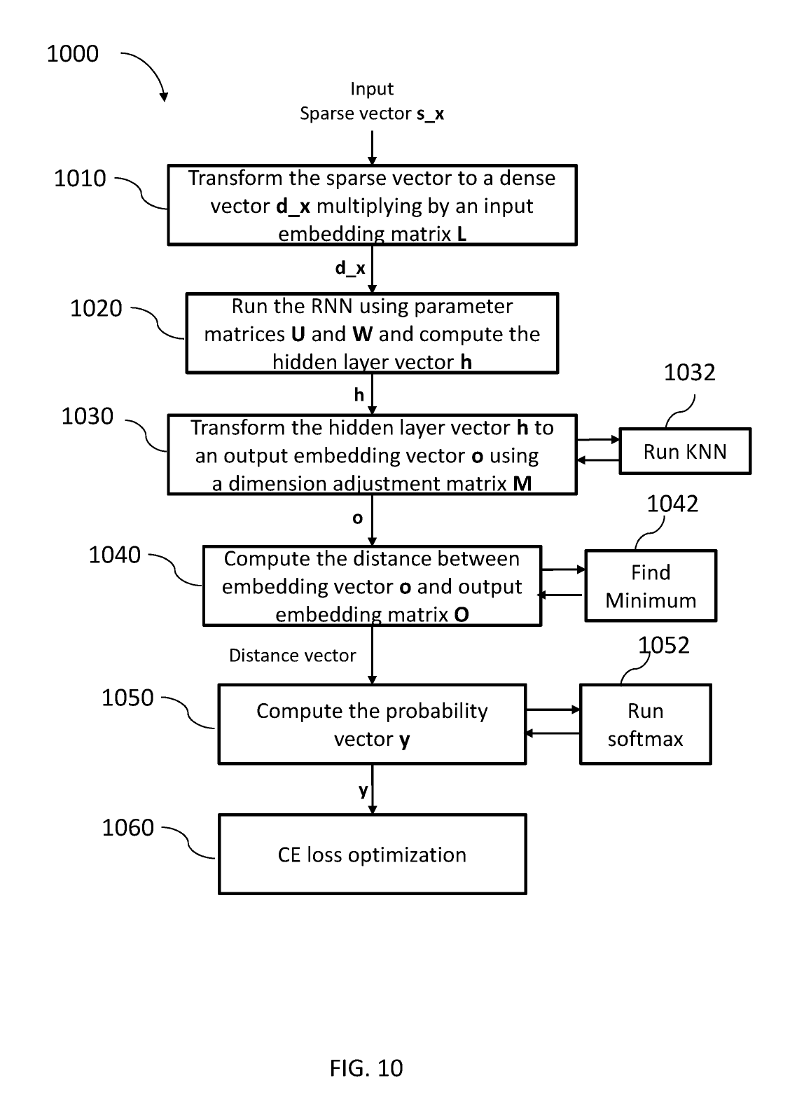

FIG. 10, to which reference is now made, is a schematic flow 1000, operative in accordance with the present invention, performed by RNN computing system 300 (FIG. 3) including steps performed inside neural network 210 and output handler 220 of system 200. In step 1010, RNN computing system 300 may transform the sparse vector s_x to a dense vector d_x by multiplying the sparse vector by an input embedding matrix L. In step 1020, RNN computing system 300 may run hidden layer computer 330 on dense vector d_x using parameter matrices U and W to compute the hidden layer vector h.

In step 1030, RNN computing system 300 may transform the hidden layer vector h to an output embedding vector o using dimension adjustment matrix M. In step 1032, computing system 300 may replace part of the RNN computation with a KNN. This is particularly useful during the inference phase. In step 1040, RNN computing system 300 may compute the distance between embedding vector o and each item in output embedding matrix O and may utilize step 1042 to find the minimum distance. In step 1050, RNN computing system 300 may compute and provide the probability vector y using a nonlinear function, such as SoftMax, shown in step 1052, and in step 1060, computing system 300 may optimize the loss during the training session. It may be appreciated by the skilled person that the steps shown are not intended to be limiting and that the flow may be practiced with more or less steps, or with a different sequence of steps, or with any combination thereof.

It may be appreciated that the total complexity of an RNN using distance transformer 720 is lower than the complexity of an RNN using standard transformer 710. The complexity of computing the linear part is O(d) while the complexity of the standard RNN computation is O(v) when v is very large. Since d is much smaller than v, a complexity of O(d) is a great savings.

It may also be appreciated that the total complexity of an RNN using RNN computing system 300 may be less than in the prior art since the complexities of SoftMax, KNN, and finding a minimum are constant (of O(1)).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for a neural network, the method comprising:
concurrently calculating a distance vector between an output feature vector of said neural network and each of a plurality of qualified feature vectors, wherein said output feature vector describes an unclassified item, and each of said plurality of qualified feature vectors describes one classified item out of a collection of classified items;
concurrently computing a similarity score for each distance vector; and
creating a similarity score vector of said plurality of computed similarity scores.

2. The method of claim 1 also comprising reducing a size of an input vector of said neural network by concurrently multiplying said input vector by a plurality of columns of an input embedding matrix.

3. The method of claim 1 also comprising concurrently activating a nonlinear function on all elements of said similarity score vector to provide a probability distribution vector.

4. The method of claim 3 wherein said nonlinear function is the SoftMax function.

5. The method of claim 3 also comprising finding an extreme value in said probability distribution vector to find a classified item most similar to said unclassified item with a computation complexity of O(1).

6. The method of claim 1 also comprising activating a K-nearest neighbors (KNN) function on said similarity score vector to provide k classified items most similar to said unclassified item.

7. A system for a neural network, the system comprising:
an associative memory array comprised of rows and columns;
an input arranger to store information regarding an unclassified item in said associative memory array, to manipulate said information and to create input to said neural network;
a hidden layer computer to receive said input and to run said input in said neural network to compute a hidden layer vector; and
an output handler to transform said hidden layer vector to an output feature vector, to concurrently calculate, within said associative memory array, a distance vector between said output feature vector and each of a plurality of qualified feature vectors, each describing one classified item, and to concurrently compute, within said associative memory array, a similarity score for each distance vector.

8. The system of claim 7 and also comprising said input arranger to reduce the dimension of said information.

9. The system of claim 7 wherein said output handler also comprises a linear module and a nonlinear module.

10. The system of claim 8 wherein said nonlinear module implements a SoftMax function to create a probability distribution vector from a vector of said similarity scores.

11. The system of claim 10 and also comprising an extreme value finder to find an extreme value in said probability distribution vector.

12. The system of claim 8 wherein said nonlinear module is a k-nearest neighbors module to provide k classified items most similar to said unclassified item.

13. The system of claim 8 wherein said linear module is a distance transformer to generate said similarity scores.

14. The system of claim 13 wherein said distance transformer comprises a vector adjuster and a distance calculator.

15. The system of claim 14 said distance transformer to store columns of an adjustment matrix in first computation columns of said memory array, and to distribute said hidden layer vector to each computation column, and said vector adjuster to compute an output feature vector within said first computation columns.

16. The system of claim 15 said distance transformer to initially store columns of an output embedding matrix in second computation columns of said associative memory array and to distribute said output feature vector to all said second computation columns, and said distance calculator to compute a distance vector within said second computation columns.

17. A method for comparing an unclassified item described by an unclassified vector of features to a plurality of classified items, each described by a classified vector of features, the method comprising:
concurrently computing a distance vector between said unclassified vector and each said classified vector; and
concurrently computing a distance scalar for each distance vector, each distance scalar providing a similarity score between said unclassified item and one of said plurality of classified items thereby creating a similarity score vector comprising a plurality of distance scalars.

18. The method of claim 17 and also comprising activating a nonlinear function on said similarity score vector to create a probability distribution vector.

19. The method of claim 18 wherein said nonlinear function is the SoftMax function.

20. The method of claim 18 and also comprising finding an extreme value in said probability distribution vector to find a classified item most similar to said unclassified item.

21. The method of claim 18 and also comprising activating a K-nearest neighbors (KNN) function on said similarity score vector to provide k classified items most similar to said unclassified item.
